(19) United States
(12) Patent Application Publication
(10) Pub. No.: US 2020/0391287 A1
(43) Pub. Date: Dec. 17, 2020

(54) COMPOUND POWDER

(71) Applicant: HITACHI CHEMICAL COMPANY, LTD., Tokyo (JP)

(72) Inventors: Kazumasa TAKEUCHI, Chiyoda-ku, Tokyo (JP); Chio ISHIHARA, Chiyoda-ku, Tokyo (JP); Hideo MAEDA, Chiyoda-ku, Tokyo (JP); Teruo ITOH, Chiyoda-ku, Tokyo (JP); Hayato SAWAMOTO, Chiyoda-ku, Tokyo (JP); Kohei AIBA, Chiyoda-ku, Tokyo (JP)

(21) Appl. No.: 16/971,796

(22) PCT Filed: Feb. 28, 2018
(86) PCT No.: PCT/JP2018/007578

§ 371 Date: Aug. 21, 2020

(51) Int. Cl. B22F 1/02; H01F 1/08; B22F 1/00

(52) U.S. Cl. CPC B22F 1/02; B22F 2302/20; B22F 1/0062; H01F 1/08

(57) ABSTRACT

Provided is a compound powder suitable for producing a molded body having a high density. A compound powder 10 includes metal element-containing particles 1 and a resin composition 2 covering the metal element-containing particle 1, in which a melt viscosity of the resin composition 2 at 100° C. is 0.01 Pa·s or more and 10 Pa·s or less.

### TECHNICAL FIELD

The present invention relates to a compound powder.

### BACKGROUND ART

A compound powder containing a metal powder and a resin composition is used, for example, as raw materials for various industrial products such as inductors, electromagnetic shields, or bonded magnets, according to various physical properties of the metal powder (see Patent Literature 1 below).

### CITATION LIST

### Patent Literature

Patent Literature 1: Japanese Unexamined Patent Publication No. H10-154613

### SUMMARY OF INVENTION

### Technical Problem

In the case of producing an industrial product from a compound powder, a molded body having a shape corresponding to the use of the industrial product is produced from the compound powder. Since the molded body also contains a resin composition as well as a metal powder, the density of the molded body is smaller than the true density of metal itself constituting the metal powder. As the density of the molded body is smaller, various characteristics derived from the metal powder may not be obtained sufficiently.

An object of the present invention is to provide a compound powder suitable for producing a molded body having a high density.

### Solution to Problem

A compound powder according to an aspect of the present invention includes metal element-containing particles and a resin composition covering the metal element-containing particle, in which a melt viscosity of the resin composition at 100° C. is 0.01 Pa·s or more and 10 Pa·s or less.

In the compound powder according to the aspect of the present invention, a melt viscosity of the resin composition at 30° C. may be 10 Pa·s or more and 100 Pa·s or less.

In the compound powder according to the aspect of the present invention, a coating compound covering the metal element-containing particle may be interposed between the metal element-containing particle and the resin composition, and the coating compound may have an alkyl chain.

In the compound powder according to the aspect of the present invention, the number of carbon atoms of the alkyl chain may be 4 or more and 30 or less.

The compound powder according to the aspect of the present invention may be used in a bonded magnet.

### Advantageous Effects of Invention

According to the present invention, there is provided a compound powder suitable for producing a molded body having a high density.

### BRIEF DESCRIPTION OF DRAWINGS

FIG. 1 is a schematic view of a cross-section of a compound powder of an embodiment of the present invention.

FIG. 2 is a schematic view of a cross-section of a compound powder of an embodiment of the present invention.

(a) in FIG. 3 is an image of a dispersion liquid (a dispersion liquid immediately after production) of Reference Example 1 put in a glass bottle, (b) in FIG. 3 is an image of the dispersion liquid (the dispersion liquid after being left to stand still on a neodymium magnet) of Reference Example 1 put in the glass bottle, (c) in FIG. 3 is an image of a dispersion liquid (a dispersion liquid immediately after production) of Reference Example 2 put in a glass bottle, and (d) in FIG. 3 is an image of the dispersion liquid (the dispersion liquid after being left to stand still on a neodymium magnet) of Reference Example 2 put in the glass bottle.

### DESCRIPTION OF EMBODIMENTS

Hereinafter, preferred embodiments of the present invention will be described. However, the present invention is not limited to the following embodiments at all.

<Compound Powder>

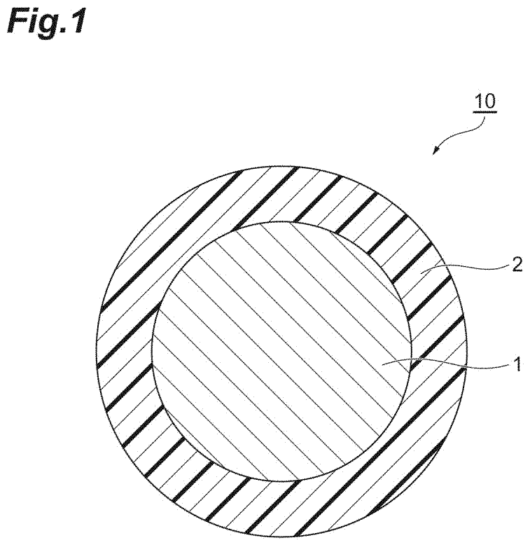

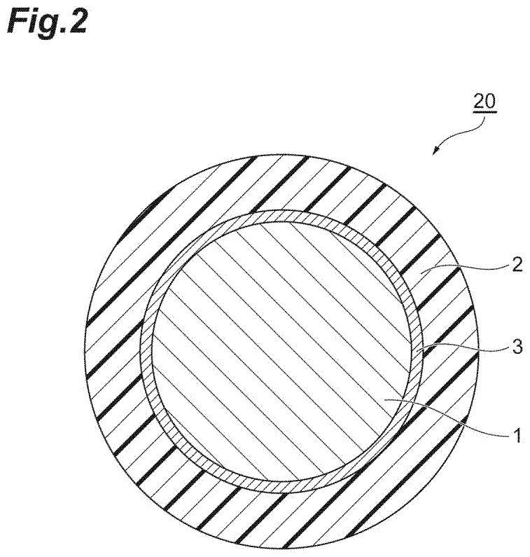

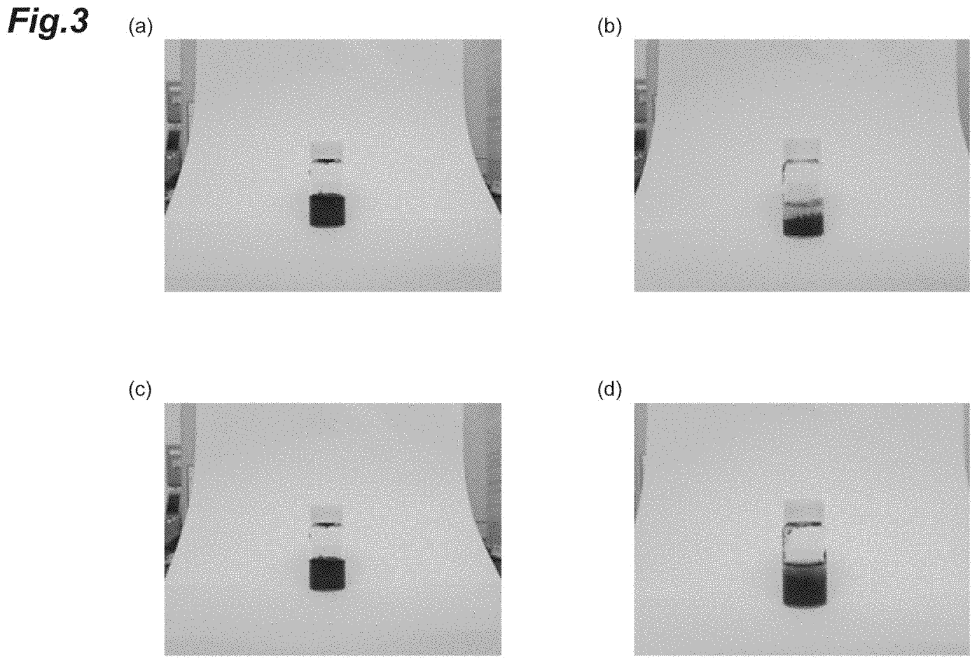

As illustrated in FIG. 1, a compound powder 10 of the present embodiment includes a plurality (a large number) of metal element-containing particles 1 and a resin composition 2 covering each metal element-containing particle 1. That is, each particle constituting the compound powder 10 has the metal element-containing particle 1 and the resin composition 2 covering the metal element-containing particle 1. For example, a layer containing the resin composition 2 (a layer composed of the resin composition 2, or the like) may cover the surface of the metal element-containing particle 1. Each particle including the metal element-containing particle 1 and the resin composition 2 covering the metal element-containing particle 1 is denoted as a “resin-coated particle” in some cases. Each of the resin-coated particles constituting the compound powder 10 may include other components in addition to the metal element-containing particle 1 and the resin composition 2. For example, as illustrated in FIG. 2, in a compound powder 20 that is a modified example of the compound powder 10, a coating compound 3 covering the metal element-containing particle 1 is interposed between the metal element-containing particle 1 and the resin composition 2. For example, a layer containing the coating compound 3 (a layer composed of the coating compound 3, or the like) may cover the surface of the metal element-containing particle 1. The layer containing the resin composition 2 may cover the surface of the layer containing the coating compound 3. The coating compound 3 may be chemically adsorbed or bonded to the surface of the metal element-containing particle 1. The resin composition 2 may cover the surface of the metal element-containing particle 1 to which the coating compound 3 is adsorbed.

The metal element-containing particle 1 may contain, for example, at least one selected from the group consisting of a simple metal, an alloy, and a metal compound. The resin composition 2 contains at least a resin. The resin composition 2 is a component which may contain a resin, a curing agent, a curing accelerator, and an additive, and may be a remaining component (non-volatile component) excluding an organic solvent, the metal element-containing particle 1, and the coating compound 3. The additive is a remaining component of the resin composition 2 excluding a resin, a curing agent, and a curing accelerator. The additive is, for example, a reactive diluent, a coupling agent, a flame retardant, or the like. The resin composition 2 may contain a wax as the additive. The resin composition 2 may be uncured. The resin composition 2 may be a semi-cured product.

The melt viscosity of the resin composition 2 at 100° C. is 0.01 Pa·s or more and 10 Pa·s or less. The melt viscosity of the resin composition 2 at 100° C. may be 0.05 Pa·s or more and 10 Pa·s or less, 0.1 Pa·s or more and 10 Pa·s or less, 0.7 Pa·s or more and 10 Pa·s or less, 0.7 Pa·s or more and 2 Pa·s or less, 0.7 Pa·s or more and 1 Pa·s or less, 0.7 Pa·s or more and 0.9 Pa·s or less, 0.9 Pa·s or more and 10 Pa·s or less, 0.9 Pa·s or more and 2 Pa·s or less, 0.9 Pa·s or more and 1 Pa·s or less, 1 Pa·s or more and 10 Pa·s or less, 1 Pa·s or more and 2 Pa·s or less, or 2 Pa·s or more and 10 Pa·s or less.

When the melt viscosity of the resin composition 2 at 100° C. is 10 Pa·s or less, friction (interface friction) between the metal element-containing particle 1 and the resin composition 2 contained in the compound powder 10 is reduced. Therefore, in the process in which a molded body is formed from the compound powder 10, the metal element-containing particle 1 is likely to move in the resin composition 2, and the metal element-containing particle 1 is likely to be densely filled (through the resin composition 2). As a result, the proportion of the metal element-containing particle 1 occupied in the molded body can be increased, and thereby the density of the molded body can be increased. In a case where the metal element-containing particle 1 is covered with the coating compound 3 having an alkyl chain, friction between the metal element-containing particle 1 and the resin composition 2 contained in the compound powder 20 is further reduced, and thereby the density of the molded body can be further increased. Furthermore, when the melt viscosity of the resin composition 2 at 100° C. is 0.01 Pa·s or more, the mechanical strength of a molded body formed from the compound powders 10, 20 can be increased. Therefore, when the melt viscosity of the resin composition 2 at 100° C. is 0.01 Pa·s or more and 10 Pa·s or less, a molded body having both of a high density and a high mechanical strength can be produced. The melt viscosity of the resin composition 2 may be freely adjusted by the composition of a resin contained in the resin composition 2, the combination and the mixing ratio of a plurality of kinds of resins, the combination and the mixing ratio of each of resins and reactive diluents, the composition and the mixing ratio of each of curing agents, curing accelerators, and additives in the resin composition 2, or the like. However, the function effect of the present invention is not limited to the above-described matters.

The melt viscosity of the resin composition 2 at 30° C. may be 10 Pa·s or more and 100 Pa·s or less, 20 Pa·s or more and 90 Pa·s or less, or 30 Pa·s or more and 80 Pa·s or less. In a case where the melt viscosity of the resin composition 2 at 30° C. is 100 Pa·s or less, the metal element-containing particle 1 is likely to move in the resin composition 2, and the density of the molded body is likely to be increased. In a case where the melt viscosity of the resin composition 2 at 30° C. is 10 Pa·s or more, the mechanical strength of the molded body is likely to be increased.

The rest of a plurality (a large number) of particles excluding the resin composition 2 from the compound powders 10, 20 is denoted as “metal element-containing powder” in some cases. The metal element-containing powder includes a plurality (a large number) of metal element-containing particles 1. The metal element-containing powder may be composed of only the metal element-containing particles 1. The metal element-containing powder may include a plurality (a large number) of metal element-containing particles 1 and a coating compound 3 covering the surface of each metal element-containing particle 1. That is, each particle constituting the metal element-containing powder may have the metal element-containing particle 1 and the coating compound 3 covering the surface of the metal element-containing particle 1. The resin composition 2 may cover at least a part or whole of each of the particles constituting the metal element-containing powder. The resin composition 2 may adhere to the surface of each of the particles constituting the metal element-containing powder. The resin composition 2 may adhere to the whole surface of each of the particles constituting the metal element-containing powder or may adhere to only a part of the surface of the particle. The coating compound 3 may cover at least a part or whole of the surface of the metal element-containing particle 1. The compound powders 10, 20 may include the uncured resin composition 2 and the metal element-containing powder. The compound powders 10, 20 may include a semi-cured product of the resin composition 2 (for example, B-stage resin composition 2) and the metal element-containing powder. The compound powders 10, 20 may be formed from the metal element-containing powder and the resin composition 2.

The content of the metal element-containing particle 1 in the compound powders 10, 20 may be 89.0% by mass or more and 99.8% by mass or less with respect to the mass of the whole compound powder.

The content of the resin composition 2 in the compound powders 10, 20 may be 0.2% by mass or more and 10% by mass or less and may be preferably 1% by mass or more and 4% by mass or less, with respect to the mass of the whole compound powder.

The content of the coating compound 3 in the compound powder 20 may be 0.001% by mass or more and 1.00% by mass or less with respect to the mass of the whole compound powder. In a case where the content of the coating compound 3 is within the above-described range, the content of the metal element-containing particle 1 in the molded body is likely to be increased, and thereby the density of the molded body is likely to be increased.

The average particles size of the respective resin-coated particles constituting the compound powders 10, 20 may be, for example, 1 μm or more and 300 μm or less. The thickness of the resin composition 2 (layer) covering the metal element-containing particle 1 may be, for example, 0.1 μm or more and 10 μm or less. The average particles size of the metal element-containing particle 1 may be, for example, 1 μm or more and 300 μm or less. The average particles size may be measured, for example, by a particle size distribution meter. The shape of the metal element-containing particle 1 may be, for example, a spherical shape, a flat shape, a prismatic shape, or a needle shape, and is not particularly limited. In a case where the shape of the metal element-containing particle 1 is a spherical shape, the density of the molded body is likely to be increased. The compound powders 10, 20 may include a plurality of kinds of metal element-containing particles 1 each having a different average particles size. Since the thickness of the coating compound 3 is its molecular level and very smaller than the particle size of the metal element-containing particle 1, the average particles size of the whole metal element-containing particle 1 covered with the coating compound 3 is almost equal to the average particles size of the metal element-containing particle 1 not covered with the coating compound 3.

Various characteristics such as electromagnetic characteristics of a molded body formed from the compound powders 10, 20 are freely controlled according to the composition or the combination of the metal element-containing particles 1 contained in the compound powders 10, 20, and the molded body can be used for various industrial products or raw materials therefor. Industrial products produced using the compound powders 10, 20 may be, for example, automobiles, medical equipment, electronic equipment, electrical equipment, information communications equipment, home electronics, sound equipment, and general industrial equipment. For example, in a case where the compound powders 10, 20 contain a permanent magnet such as an Sm—Fe—N-based alloy or an Nd—Fe—B-based alloy as the metal element-containing particle 1, the compound powders 10, 20 may be used as raw materials for a bonded magnet. In a case where the compound powders 10, 20 contain a soft magnetic powder such as an Fe—Si—Cr-based alloy or ferrite as the metal element-containing particle 1, the compound powders 10, 20 may be used as raw materials (for example, a magnetic core) for an inductor (for example, an EMI filter) or a transformer. In a case where the compound powders 10, 20 contain iron and copper as the metal element-containing particle 1, a molded body (for example, a sheet) formed from the compound powders 10, 20 may be used as an electromagnetic shield.

(Details of Resin Composition)

The resin composition 2 has a function as a bonding material (binder) of the metal element-containing powder and provides the mechanical strength to a molded body formed from the compound powders 10, 20. For example, when the compound powders 10, 20 are molded at a high pressure by using a mold, the resin composition 2 contained in the compound powders 10, 20 is filled between particles constituting the metal element-containing powder and binds the particles to each other. The resin composition 2 in the molded body is cured, and thereby the cured product of the resin composition 2 more firmly binds the particles constituting the metal element-containing powder to each other, so that the mechanical strength of the molded body is improved.

The resin composition 2 may contain a thermosetting resin. The thermosetting resin may be, for example, at least one selected from the group consisting of an epoxy resin, a phenolic resin, and a polyamide-imide resin. In a case where the resin composition 2 contains both of an epoxy resin and a phenolic resin, the phenolic resin may function as a curing agent for the epoxy resin. The resin composition 2 may contain a thermoplastic resin. The thermoplastic resin may be, for example, at least one selected from the group consisting of an acrylic resin, polyethylene, polypropylene, polystyrene, polyvinyl chloride, and polyethylene terephthalate. The resin composition 2 may contain both of a thermosetting resin and a thermoplastic resin. The resin composition 2 may contain a silicone resin.

Since the epoxy resin is excellent in fluidity among thermosetting resins, the resin composition 2 preferably contains the epoxy resin. The epoxy resin may be, for example, a resin having two or more epoxy groups in one molecule.

The epoxy resin may be at least one selected from the group consisting of a liquid epoxy resin, a semisolid epoxy resin, and a solid epoxy resin. In a case where the epoxy resin is a liquid epoxy resin, from the viewpoint of easily controlling the melt viscosity of the resin composition 2 at 100° C. to 0.01 Pa·s or more and 10 Pa·s or less, the melt viscosity of the epoxy resin at 25° C. may be preferably 1 Pa·s or more and 50 Pa·s or less and more preferably 3 Pa·s or more and 15 Pa·s or less. The liquid epoxy resin having the above-described melt viscosity is preferably at least one selected from the group consisting of a bisphenol F type epoxy resin, a bisphenol A type epoxy resin, and an alkylphenol type epoxy resin. In a case where the epoxy resin is a semisolid epoxy resin or a solid epoxy resin, from the viewpoint of easily controlling the melt viscosity of the resin composition 2 at 100° C. to 0.01 Pa·s or more and 10 Pa·s or less, the ICI viscosity of the epoxy resin may be preferably 0.01 Pa·s or more and 2 Pa·s or less. The ICI viscosity refers to a melt viscosity at 150° C. The solid epoxy resin is preferably at least one selected from the group consisting of a biphenyl aralkyl type epoxy resin, a dicyclopentadiene novolac type epoxy resin, a naphthalene novolac type epoxy resin, a salicylaldehyde type novolac-modified epoxy resin, an ortho-cresol type epoxy resin, a phenol novolac type epoxy resin, a brominated novolac epoxy resin, a cresol novolac type epoxy resin, a novolac type epoxy resin, a dicyclopentadiene type epoxy resin, and a naphthalene type epoxy resin.

As commercially available products of the liquid epoxy resin, resins from RE-3035-L to YL983U listed below are preferred.

Bisphenol F type epoxy resin:

RE-3035-L (4.5 to 7.0 Pa·s at 25° C.)

Bisphenol A type epoxy resin:

RE-310 (12.0 to 18.0 Pa·s at 25° C.)

The above resins are resins manufactured by Nippon Kayaku Co., Ltd.

Bisphenol A type epoxy resin:

EPICLON 840 (9 to 11 Pa·s at 25° C.)

EPICLON 840S (9 to 11 Pa·s at 25° C.)

EPICLON 850 (11 to 15 Pa·s at 25° C.)

EPICLON 850S (11 to 15 Pa·s at 25° C.)

EXA850CRP (3.5 to 5.5 Pa·s at 25° C.)

EPICLON 850LC (15 to 25 Pa·s at 25° C.)

Bisphenol F type epoxy resin:

EPICLON 830 (3 to 4 Pa·s at 25° C.)

EPICLON 830S (3 to 4.5 Pa·s at 25° C.)

EPICLON 835 (3 to 4.5 Pa·s at 25° C.)

EXA830CRP (1.1 to 1.5 Pa·s at 25° C.)

EXA830LVP (1.2 to 1.8 Pa·s at 25° C.)

EXA835LV (2.0 to 2.5 Pa·s at 25° C.)

Alkylphenol type epoxy resin:

HP820 (1.0 to 3.0 Pa·s at 25° C.)

The above resins are resins manufactured by DIC Corporation.

Bisphenol A type epoxy resin:

JER825 (4 to 7 Pa·s at 25° C.)

JER827 (9 to 11 Pa·s at 25° C.)

JER828 (12 to 15 Pa·s at 25° C.)

JER828EL (12 to 15 Pa·s at 25° C.)

JER828US (12 to 15 Pa·s at 25° C.)

JER828XA (15 to 23 Pa·s at 25° C.)

YL6810 (4 to 5.5 Pa·s at 25° C.)

YL98L (10 to 20 Pa·s at 25° C.)

Bisphenol F type epoxy resin:

JER806 (1.5 to 2.5 Pa·s at 25° C.)

JER806H (2 to 4 Pa·s at 25° C.)

JER807 (3 to 4.5 Pa·s at 25° C.)

JER1750 (1 to 1.5 Pa·s at 25° C.)

YL983U (3 to 6 Pa·s at 25° C.)

The above resins are resins manufactured by Mitsubishi Chemical Corporation.

As commercially available products of the solid epoxy resin, resins from NC3000 to YL6121HA listed below are preferred. Biphenyl aralkyl type epoxy resin:

NC-3000 (0.04 to 0.11 Pa·s at 150° C.)

NC-3000-L (0.01 to 0.07 Pa·s at 150° C.)

NC-3000-H (0.25 to 0.35 Pa·s at 150° C.)

NC-3100 (0.01 to 0.35 Pa·s at 150° C.)

NC-2000-L (0.01 to 0.15 Pa·s at 150° C.)

Dicyclopentadiene novolac type epoxy resin:

XD-1000 (0.15 to 0.30 Pa·s at 150° C.)

Naphthalene novolac type epoxy resin:

NC-7300L (0.01 to 0.10 Pa·s at 150° C.)

Salicylaldehyde type novolac-modified epoxy resin:

EPPN-501H (0.05 to 0.11 Pa·s at 150° C.)

EPPN-501HY (0.06 to 0.14 Pa·s at 150° C.)

EPPN502H (0.01 to 0.35 Pa·s at 150° C.)

Ortho-cresol type epoxy resin:

EOCN-1020 (0.06 to 1.20 Pa·s at 150° C.)

EOCN-1025 (0.06 to 0.73 Pa·s at 150° C.)

Phenol novolac type epoxy resin:

EPPN-201 (0.40 to 0.60 Pa·s at 150° C.)

Brominated novolac epoxy resin:

BREN-105 (0.12 to 0.20 Pa·s at 150° C.)

The above resins are resins manufactured by Nippon Kayaku Co., Ltd.

Bisphenol A type epoxy resin:

EPICLON 860 (0.3 to 0.4 Pa·s at 150° C.)

EPICLON 1050 (1.2 to 1.3 Pa·s at 150° C.)

Cresol novolac type epoxy resin:

EPICLON N660 (0.1 to 0.3 Pa·s at 150° C.)

EPICLON N665 (0.20 to 0.4 Pa·s at 150° C.)

EPICLON N670 (0.35 to 0.55 Pa·s at 150° C.)

EPICLON N673 (0.50 to 0.75 Pa·s at 150° C.)

EPICLON N680 (1.0 to 1.6 Pa·s at 150° C.)

EPICLON N665EXP (0.25 to 0.40 Pa·s at 150° C.)

EPICLON N672EXP (0.45 to 0.60 Pa·s at 150° C.)

EPICLON N655EXP-S (0.05 to 0.20 Pa·s at 150° C.)

EPICLON N662EXP-S (0.20 to 0.35 Pa·s at 150° C.)

EPICLON N665EXP-S (0.35 to 0.50 Pa·s at 150° C.)

EPICLON N670EXP-S (0.45 to 0.60 Pa·s at 150° C.)

EPICLON N685EXP-S (0.90 to 1.5 Pa·s at 150° C.)

Novolac type epoxy resin:

EPICLON N770 (0.35 to 0.60 Pa·s at 150° C.)

EPICLON N775 (0.55 to 0.90 Pa·s at 150° C.)

EPICLON N865 (0.15 to 0.40 Pa·s at 150° C.)

Dicyclopentadiene type epoxy resin:

EPICLON HP-7200L (0.01 to 0.10 Pa·s at 150° C.)

EPICLON HP-7200 (0.1 to 0.20 Pa·s at 150° C.)

EPICLON HP-7200H (0.20 to 0.60 Pa·s at 150° C.)

EPICLON HP-7200HH (0.40 to 1.20 Pa·s at 150° C.)

Naphthalene type epoxy resin:

EPICLON HP-4700 (0.30 to 0.60 Pa·s at 150° C.)

EPICLON HP-4770 (0.1 to 0.20 Pa·s at 150° C.)

EPICLON HP-5000 (0.3 to 1.50 Pa·s at 150° C.)

EPICLON HP-6000 (0.15 to 3.0 Pa·s at 150° C.)

EPICLON HP-4710 (0.40 to 1.40 Pa·s at 150° C.)

The above resins are resins manufactured by DIC Corporation.

Biphenyl type epoxy resin:

YX4000 (0.2 Pa·s at 150° C.)

YX4000H (0.2 Pa·s at 25° C.)

YL6121HA (0.15 Pa·s at 25° C.)

The above resins are resins manufactured by Mitsubishi Chemical Corporation.

The resin composition 2 may contain other epoxy resins in addition to the above-described epoxy resin. The other epoxy resins may be, for example, at least one selected from the group consisting of a stilbene type epoxy resin, a diphenylmethane type epoxy resin, a sulfur atom-containing type epoxy resin, a copolymer type epoxy resin of naphthols and phenols, a glycidyl ether type epoxy resin of alcohols, a glycidyl ether type epoxy resin of a para-xylylene and/or meta-xylylene-modified phenolic resin, a glycidyl ether type epoxy resin of a terpene-modified phenolic resin, a glycidyl ether type epoxy resin of a polycyclic aromatic ring-modified phenolic resin, a glycidyl ether type epoxy resin of a naphthalene ring-containing phenolic resin, a glycidyl ester type epoxy resin, a glycidyl type or methylglycidyl type epoxy resin, an alicyclic type epoxy resin, a hydroquinone type epoxy resin, a trimethylolpropane type epoxy resin, and a linear aliphatic epoxy resin obtained by oxidation of an olefin bond with a peracid such as peracetic acid.

The resin composition 2 may contain one kind of the above-described epoxy resins. The resin composition 2 may contain a plurality of kinds of the above-described epoxy resins. From the viewpoint of easily adjusting the melt viscosity of the resin composition 2 within the above-described range, the resin composition 2 preferably contains a biphenyl type epoxy resin among the above-described epoxy resins. The resin composition 2 preferably contains both of a biphenyl type epoxy resin (YX-4000H) and an ortho-cresol novolac type epoxy resin (N500P-2).

The resin composition 2 may contain a reactive diluent. The resin composition 2 may contain an epoxy resin and a reactive diluent. The epoxy resin is diluted with the reactive diluent, and thereby the melt viscosity of the resin composition 2 is easily adjusted within the above-described range. The reactive diluent may be, for example, at least any one of a monoepoxy compound and a diepoxy compound. The reactive diluent may be a monofunctional epoxy resin. The reactive diluent may be, for example, at least one selected from the group consisting of alkyl monoglycidyl ether, alkylphenol monoglycidyl ether, and alkyl diglycidyl ether. As commercially available products of the alkyl monoglycidyl ether, for example, YED188 or YED111N manufactured by Mitsubishi Chemical Corporation may be used. As commercially available products of the alkylphenol monoglycidyl ether, for example, EPICLON 520 manufactured by DIC Corporation or YED122 manufactured by Mitsubishi Chemical Corporation may be used. As commercially available products of the alkyl diglycidyl ether, for example, YED216M or YED216D manufactured by Mitsubishi Chemical Corporation may be used.

The curing agent is classified into a curing agent which cures the epoxy resin in a range of a low temperature to room temperature and a heat curing type curing agent which cures the epoxy resin by heating. Examples of the curing agent which cures the epoxy resin in a range of a low temperature to room temperature include aliphatic polyamine, polyaminoamide, and polymercaptan. Examples of the heat curing type curing agent include aromatic polyamine, acid anhydride, a phenol novolac resin, and dicyandiamide (DICY).

In the case of using the curing agent which cures the epoxy resin in a range of a low temperature to room temperature, the glass transition point of a cured product of the epoxy resin is low, and the cured product of the epoxy resin tends to be soft. As a result, a molded body formed from the compound powders 10, 20 is also likely to be soft. On the other hand, from the viewpoint of improving heat resistance of the molded body, the curing agent may be preferably a heat curing type curing agent, more preferably a phenolic resin, and even more preferably a phenol novolac resin. In particular, by using a phenol novolac resin as the curing agent, a cured product of the epoxy resin having a high glass transition point is easily obtained. As a result, the heat resistance and the mechanical strength of the molded body are likely to be improved.

The phenolic resin may be, for example, at least one selected from the group consisting of an aralkyl type phenolic resin, a dicyclopentadiene type phenolic resin, a salicylaldehyde type phenolic resin, a novolac type phenolic resin, a copolymer type phenolic resin of benzaldehyde type phenol and aralkyl type phenol, a para-xylylene and/or meta-xylylene-modified phenolic resin, a melamine-modified phenolic resin, a terpene-modified phenolic resin, a dicyclopentadiene type naphthol resin, a cyclopentadiene-modified phenolic resin, a polycyclic aromatic ring-modified phenolic resin, a biphenyl type phenolic resin, and a triphenylmethane type phenolic resin. The phenolic resin may be a copolymer composed of two or more kinds of the above-described resins. As commercially available products of the phenolic resin, for example, TAMANOL 758 manufactured by ARAKAWA CHEMICAL INDUSTRIES, LTD., HP-850N manufactured by Hitachi Chemical Company, Ltd., or the like may be used.

The phenol novolac resin may be, for example, a resin obtained by condensing or co-condensing phenols and/or naphthols and aldehydes in the presence of an acidic catalyst. Phenols constituting the phenol novolac resin may be, for example, at least one selected from the group consisting of phenol, cresol, xylenol, resorcin, catechol, bisphenol A, bisphenol F, phenylphenol, and aminophenol. Naphthols constituting the phenol novolac resin may be, for example, at least one selected from the group consisting of α-naphthol, β-naphthol, and dihydroxynaphthalene. Aldehydes constituting the phenol novolac resin may be, for example, at least one selected from the group consisting of formaldehyde, acetaldehyde, propionaldehyde, benzaldehyde, and salicylaldehyde.

The curing agent may be, for example, a compound having two phenolic hydroxyl groups in one molecule. The compound having two phenolic hydroxyl groups in one molecule may be, for example, at least one selected from the group consisting of resorcin, catechol, bisphenol A, bisphenol F, and a substituted or unsubstituted biphenol.

The resin composition 2 may contain one kind of the above-described phenolic resins. The resin composition 2 may include a plurality of kinds of the above-described phenolic resins. The resin composition 2 may contain one kind of the above-described curing agents. The resin composition 2 may contain a plurality of kinds of the above-described curing agents.

The ratio of the active group (phenolic OH group) in the curing agent which reacts with the epoxy group in the epoxy resin may be preferably 0.5 to 1.5 equivalents, more preferably 0.9 to 1.4 equivalents, and even more preferably 1.0 to 1.2 equivalents, with respect to one equivalent of the epoxy group in the epoxy resin. In a case where the ratio of the active group in the curing agent is less than 0.5 equivalents, the OH amount per unit weight of the epoxy resin after curing is decreased, and thereby the curing rate of the resin composition 2 (epoxy resin) is decreased. Furthermore, in a case where the ratio of the active group in the curing agent is less than 0.5 equivalents, the glass transition temperature of a cured product to be obtained may be decreased or a sufficient elastic modulus of a cured product may not be obtained. On the other hand, in a case where the ratio of the active group in the curing agent is more than 1.5 equivalents, the mechanical strength after curing of a molded body formed from the compound powders 10, 20 tends to decrease. However, even in a case where the ratio of the active group in the curing agent is out of the above-described range, the effect of the present invention is obtainable.

For example, the curing accelerator is not limited as long as it is a composition that reacts with the epoxy resin to accelerate curing of the epoxy resin. The curing accelerator may be, for example, imidazoles such as alkyl group-substituted imidazole or benzoimidazole. The resin composition 2 may include one kind of curing accelerators. The resin composition 2 may include a plurality of kinds of curing accelerators. By containing the curing accelerator as a component of the resin composition 2, the moldability and the releasability of the compound are likely to be improved. Furthermore, by containing the curing accelerator as a component of the resin composition 2, the mechanical strength of a molded body (for example, an electronic component) produced using the compound may be improved or the storage stability of the compound in a high-temperature and high-humidity environment may be improved.

The mixing amount of the curing accelerator is sufficient to be an amount in which the curing acceleration effect is obtainable, and the mixing amount is not particularly limited. However, from the viewpoint of improving curing property and fluidity when the resin composition 2 absorbs moisture, the mixing amount of the curing accelerator may be preferably 0.1 parts by mass or more and 30 parts by mass or less and more preferably 1 part by mass or more and 15 parts by mass or less, with respect to 100 parts by mass of the epoxy resin. The content of the curing accelerator is preferably 0.001 parts by mass or more and 5 parts by mass or less with respect to the total mass of the epoxy resin and the curing agent (for example, a phenolic resin). In a case where the mixing amount of the curing accelerator is less than 0.1 parts by mass, it is difficult to obtain a sufficient curing acceleration effect. In a case where the mixing amount of the curing accelerator is more than 30 parts by mass, the storage stability of the compound powders 10, 20 is likely to be decreased. However, even in a case where the mixing amount and the content of the curing accelerator are out of the above-described ranges, the effect of the present invention is obtainable.

The coupling agent improves adhesiveness between the resin composition 2 and the particles constituting the metal element-containing powder and improves the flexibility and the mechanical strength of a molded body formed from the compound powders 10, 20. The coupling agent may be, for example, at least one selected from the group consisting of a silane-based compound (silane coupling agent), a titanium-based compound, an aluminum compound (aluminum chelates), and an aluminum/zirconium-based compound. The silane coupling agent may be, for example, at least one selected from the group consisting of epoxysilane, mercaptosilane, aminosilane, alkylsilane, ureidosilane, acid anhydride-based silane, and vinylsilane. In particular, an aminophenyl-based silane coupling agent is preferred. The compound powders 10, 20 may include one kind of the above-described coupling agents or may include a plurality of kinds of the above-described coupling agents.

For environment safety, recyclability, molding processability, and cost saving of the compound powders 10, 20, the resin composition 2 may contain a flame retardant. The flame retardant may be, for example, at least one selected from the group consisting of a bromine-based flame retardant, a phosphorus-based flame retardant, a hydrated metal compound-based flame retardant, a silicone-based flame retardant, a nitrogen-containing compound, a hindered amine compound, an organometallic compound, and aromatic engineering plastic. The compound powders 10, 20 may include one kind of the above-described flame retardants or may include a plurality of kinds of the above-described flame retardants.

(Details of Metal Element-Containing Particle)

The metal element-containing particle 1 may contain, for example, at least one selected from the group consisting of a simple metal, an alloy, and a metal compound. The metal element-containing particle 1 may be composed of, for example, at least one selected from the group consisting of a simple metal, an alloy, and a metal compound. The alloy may contain at least one selected from the group consisting of a solid solution, a eutectic compound, and an intermetallic compound. The alloy may be, for example, stainless steel (an Fe—Cr-based alloy, an Fe—Ni—Cr-based alloy, or the like). The metal compound may be, for example, an oxide such as ferrite. The metal element-containing particle 1 may contain one kind of metal elements or a plurality of kinds of metal elements. The metal element contained in the metal element-containing particle 1 may be, for example, a base metal element, a noble metal element, a transition metal element, or a rare-earth element. The metal element contained in the metal element-containing particle 1 may be, for example, at least one selected from the group consisting of iron (Fe), copper (Cu), titanium (Ti), manganese (Mn), cobalt (Co), nickel (Ni), zinc (Zn), aluminum (Al), tin (Sn), chromium (Cr), barium (Ba), strontium (Sr), lead (Pb), silver (Ag), praseodymium (Pr), neodymium (Nd), samarium (Sm), and dysprosium (Dy). The metal element-containing particle 1 may contain elements other than the metal element. The metal element-containing particle 1 may contain, for example, oxygen (O), beryllium (Be), phosphorus (P), boron (B), or silicon (Si). The metal element-containing particle 1 may be a magnetic powder. The metal element-containing particle 1 may be a soft magnetic alloy or a ferromagnetic alloy. The metal element-containing particle 1 may be, for example, at least one selected from the group consisting of an Fe—Si-based alloy, an Fe—Si—Al-based alloy (sendust), an Fe—Ni-based alloy (permalloy), an Fe—Cu—Ni-based alloy (permalloy), an Fe—Co-based alloy (permendur), an Fe—Cr—Si-based alloy (electromagnetic stainless steel), an Nd—Fe—B-based alloy (rare-earth magnet), an Sm—Fe—N-based alloy (rare-earth magnet), an Al—Ni—Co-based alloy (alnico magnet), and ferrite. The ferrite may be, for example, spinel ferrite, hexagonal ferrite, or garnet ferrite. The metal element-containing particle 1 may be a copper alloy such as a Cu—Sn-based alloy, a Cu—Sn—P-based alloy, a Cu—Ni-based alloy, or a Cu—Be-based alloy. The metal element-containing particle 1 may contain one kind of the above-described elements and compositions or may contain a plurality of kinds of the above-described elements and compositions.

The metal element-containing particle 1 may be an Fe simple substance. The metal element-containing particle 1 may be an alloy containing iron (Fe-based alloy). The Fe-based alloy may be, for example, an Fe—Si—Cr-based alloy or an Nd—Fe—B-based alloy. In a case where the compound powders 10, 20 contain at least any one of an Fe simple substance and an Fe-based alloy as the metal element-containing particle 1, it is easy to produce a molded body having a high space factor and excellent magnetic property from the compound powders 10, 20. The metal element-containing particle 1 may be an Fe amorphous alloy. As commercially available products of the Fe amorphous alloy powder, for example, at least one selected from the group consisting of AW2-08 and KUAMET-6B2 (all of which are manufactured by EPSON ATMIX Corporation, trade names), DAP MS3, DAP MS7, DAP MSA10, DAP PB, DAP PC, DAP MKV49, DAP 410L, DAP 430L, and DAP HYB series (all of which are manufactured by Daido Steel Co., Ltd., trade names), and MH45D, MH28D, MH25D, and MH20D (all of which are manufactured by Kobe Steel, Ltd., trade names) may be used.

(Details of Coating Compound)

The coating compound 3 may have an alkyl chain. In a case where the metal element-containing particle 1 is covered with the coating compound 3 having an alkyl chain, since the alkyl chain of the coating compound 3 is interposed between the metal element-containing particles 1 adjacent to each other, the respective metal element-containing particles 1 are difficult to be bonded to each other. That is, the respective metal element-containing particles 1 covered with the coating compound 3 are likely to slip on each other.

In a case where the metal element-containing particle 1 is covered with the coating compound 3 having an alkyl chain, since the alkyl chain is interposed between the metal element-containing particle 1 and the resin composition 2, friction (interface friction) between the metal element-containing particle 1 and the resin composition 2 is likely to be reduced. That is, the metal element-containing particle 1 and the resin composition 2 are likely to slip on each other.

As described above, the coating compound 3 having an alkyl chain reduces friction between the metal element-containing particles 1 and friction between the metal element-containing particle 1 and the resin composition 2. As a result, in the process in which a molded body is formed from the compound powder 20, the metal element-containing particle 1 is likely to be densely filled, and the content of the metal element-containing particle 1 in the molded body is likely to be increased. Therefore, the density of the molded body is likely to be increased. Furthermore, force of gravity, centrifugal force, or the like is applied from the outside to the compound powder 20, and thereby the metal element-containing particle 1 can be densely filled in the molded body so that the density of the molded body is likely to be increased.

As described above, in a case where the metal element-containing particles 1 are difficult to be bonded to each other and the metal element-containing particle 1 and the resin composition 2 are difficult to be bonded to each other, the respective metal element-containing particles 1 are likely to be oriented along the external magnetic field in the compound powder 20. Therefore, a bonded magnet produced using the compound powder 20 of the present embodiment is excellent in magnetic property.

The number of carbon atoms of the alkyl chain of the coating compound 3 may be 4 or more and 30 or less, 4 or more and 25 or less, or 4 or more and 20 or less. In a case where the number of carbon atoms of the alkyl chain is within the above-described range, friction between the metal element-containing particles 1 and friction between the metal element-containing particle 1 and the resin composition 2 are likely to be reduced. The coating compound 3 may be at least any one of a compound having a silanol group and an organophosphate compound.

[Compound having Silanol Group]

The compound having a silanol group may be, for example, at least one selected from the group consisting of an alkylsilane-based compound, an epoxysilane-based compound, an aminosilane-based compound, a cationic silane-based compound, a vinylsilane-based compound, an acrylsilane-based compound, a mercaptosilane-based compound, and composite compounds thereof The compound having a silanol group may be a hydrolysate of alkoxysilane.

The compound having a silanol group may have at least one functional group selected from the group consisting of a glycidyl group, an alkyl group, a methacryloyl group, and an amino group at an end of the compound (molecule). The end of the compound may be an end of the molecular chain or may be an end of the side chain of the molecule.

In a case where the compound having a silanol group has a glycidyl group, when a molded body is formed from the compound powder 20, the compound having a silanol group is likely to be bonded to the resin composition 2 (for example, a resin) contained in the molded body through the glycidyl group. As a result, the mechanical strength of the molded body is likely to be increased.

In a case where the compound having a silanol group has an alkyl group (for example, an alkyl chain), since the alkyl group of the compound having a silanol group is interposed between the metal element-containing particles 1 adjacent to each other, the respective metal element-containing particles 1 are difficult to be bonded to each other. That is, the respective metal element-containing particles 1 covered with the compound having a silanol group are likely to slip on each other.

Furthermore, since the alkyl group is interposed between the metal element-containing particle 1 and the resin composition 2, friction between the metal element-containing particle 1 and the resin composition 2 is likely to be reduced. That is, the metal element-containing particle 1 and the resin composition 2 are likely to slip on each other.

As described above, friction between the metal element-containing particles 1 and friction between the metal element-containing particle 1 and the resin composition 2 are reduced. As a result, in the process in which a molded body is formed from the compound powder 20, the metal element-containing particle 1 is likely to be densely filled, and the content of the metal element-containing particle 1 in the molded body is likely to be increased. Therefore, the density of the molded body is likely to be increased.

As described above, in a case where the metal element-containing particles 1 are difficult to be bonded to each other and the metal element-containing particle 1 and the resin composition 2 are difficult to be bonded to each other, the respective metal element-containing particles 1 are likely to be oriented along the external magnetic field in the compound powder 20. Therefore, in a case where the compound having a silanol group has an alkyl group, a bonded magnet produced using the compound powder 20 is excellent in magnetic property.

In a case where the compound having a silanol group has a methacryloyl group, when a molded body is formed, the compound having a silanol group is likely to be bonded to the resin composition 2 (for example, a resin) contained in the molded body through the methacryloyl group. As a result, the mechanical strength of the molded body is likely to be increased.

In a case where the compound having a silanol group has an amino group, when a molded body is formed, the compound having a silanol group is likely to be bonded to the resin composition 2 (for example, a resin) contained in the molded body through the amino group. As a result, the mechanical strength of the molded body is likely to be increased.

The compound having a silanol group may be, for example, at least one selected from the group consisting of vinyltrimethoxysilane (KBM-1003), vinyltriethoxysilane (KBE-1003), 2-(3,4-epoxycyclohexypethyltrimethoxysilane (KBM-303), 3-glycidoxypropyl methyldimethoxysilane (KBM-402), 3-glycidoxypropyl trimethoxysilane (KBM-403), p-styryltrimethoxysilane (KBM-1403), 3-methacryloxypropyl methyldimethoxysilane (KBM-502), 3-methacryloxypropyl trimethoxysilane (KBM-503), 3-methacryloxypropyl methyldiethoxysilane (KBE-502), 3-methacryloxypropyl triethoxysilane (KBE-503), 3-acryloxypropyl trimethoxysilane (KBM-5103), N-2-(aminoethyl)-3-aminopropylmethyldimethoxysilane (KBM-602), N-2-(aminoethyl)-3-aminopropyltrimethoxysilane (KBM-603), 3-aminopropyltrimethoxysilane (KBM-903), 3-aminopropyltriethoxysilane (KBE-903), 3-triethoxy silyl-N-(1,3-dimethyl-butylidene)propylamine (KBE-9103), N-phenyl-3-aminopropyltrimethoxysilane (KBM-573), N-(vinylbenzyl)-2-aminoethyl-3-aminopropyltrimethoxysilane hydrochloride (KBM-575), tris-(trimethoxysilylpropyl)isocyanurate (KBM-9659), 3-ureidopropyltrialkoxy silane (KBE-585), 3-mercaptopropylmethyldimethoxysilane (KBM-802), 3-mercaptopropyltrimethoxy silane (KBM-803), 3-isocyanatepropyltriethoxysilane (KBM-9007), octenyltrimethoxysilane (KBM-1083), glycidoxyoctyl trimethoxysilane (KBM-4803), methacryloxyoctyl trimethoxysilane (KBM-5803), methyltrimethoxysilane (KBM-13), methyltriethoxysilane (KBE-13), dimethyldimethoxysilane (KBM-22), dimethyldiethoxysilane (KBE-22), phenyl trimethoxysilane (KBM-103), phenyltriethoxysilane (KBE-103), n-propyltrimethoxysilane (KBM-3033), n-propyltriethoxysilane (KBE-3033), hexyltrimethoxysilane (KBM-3063), hexyltriethoxysilane (KBE-3063), octyltriethoxysilane (KBE-3083), decyltrimethoxysilane (KBM-3103C), 1,6-(trimethoxysilyl)hexane (KBM-3066), trifluoropropyl trimethoxysilane (KBM-7103), hexamethyldisilazane (SZ-31), and hydrolyzable group-containing siloxane (KPN-3504) (all of which are manufactured by Shin-Etsu Chemical Co., Ltd., trade names). The compound having a silanol group may be a silicone alkoxy oligomer (a silicone oligomer having an alkoxy group). The silicone alkoxy oligomer may have at least one alkoxy group of a methoxy group and an ethoxy group. The silicone alkoxy oligomer may have at least one organic substituent selected from the group consisting of an epoxy group, a methyl group, a mercapto group, an acryloyl group, a methacryloyl group, a vinyl group, and a phenyl group. The silicone alkoxy oligomer may be, for example, at least one selected from the group consisting of KR-517, X-41-1059A, X-24-9590, KR-516, X-41-1805, X-41-1818, X-41-1810, KR-513, X-40-9296, KR-511, KC-89S, KR-515, KR-500, X-40-9225, X-40-9246, X-40-9250, KR-401N, X-40-9227, KR-510, KR-9218, and KR-213 (all of which are manufactured by Shin-Etsu Chemical Co., Ltd., trade names).

The coating compound 3 may contain one kind of the above-described compounds as the compound having a silanol group. The coating compound 3 may contain a plurality of kinds of the above-described compounds as the compound having a silanol group.

[Organophosphate Compound]

The organophosphate compound may be, for example, acidic phosphoric acid esters. The organophosphate compound may be, for example, at least one selected from the group consisting of ethyl acid phosphate (JP-502), butyl acid phosphate (JP-504), dibutyl pyrophosphate (JP-504A), butoxyethyl acid phosphate (JP-506AH), 2-ethylhexyl acid phosphate (JP-508), alkyl (C12, C14, C16, C18) acid phosphate (JP-512), isotridecyl acid phosphate (JP-513), oleyl acid phosphate (JP-518-0), tetracosyl acid phosphate (JP-524R), ethyleneglycol acid phosphate (EGAP), 2-hydroxyethyl methacrylate acid phosphate (JPA-514), dibutyl phosphate (DBP), and bis(2-ethylhexyl)phosphate (LB-58) (all of which are manufactured by Johoku Chemical Co., Ltd.).

The coating compound 3 may contain one kind of the above-described organophosphate compounds. The coating compound may contain a plurality of kinds of the above-described organophosphate compounds.

<Method for Producing Metal Element-Containing Powder>

As described above, the metal element-containing powder is the rest of a plurality (a large number) of particles excluding the resin composition 2 from the compound powders 10, 20. The method for producing the metal element-containing powder composed of only the metal element-containing particle 1 is not particularly limited. The metal element-containing powder including the metal element-containing particles 1 and the coating compound 3 may be produced, for example, by a method below.

First, the coating compound 3 is dissolved in a solvent and thereby a surface treatment liquid is obtained. The solvent is not particularly limited as long as it is a liquid that dissolves the coating compound 3. The solvent may be at least one kind of water and ethanol.

Subsequently, the metal element-containing particle 1 and the surface treatment liquid are mixed and thereby a mixture is obtained. The content of the surface treatment liquid in the mixture may be 5 parts by mass or more and 10 parts by mass or less with respect to the whole mass (100 parts by mass) of the metal element-containing particles 1 contained in the mixture. In a case where the content of the surface treatment liquid is less than 5 parts by mass, the surface of the metal element-containing particle 1 is difficult to be sufficiently covered with the coating compound 3. In a case where the content of the surface treatment liquid is more than 10 parts by mass, an aggregate of the metal element-containing particles 1 is likely to be generated when the metal element-containing particles 1 and the surface treatment liquid are mixed. As a result, the surface of the metal element-containing particle 1 is difficult to be uniformly covered with the coating compound 3. In a case where the content of the surface treatment liquid is within the above-described range, the surface of the metal element-containing particle 1 is easy to be sufficiently and uniformly covered with the coating compound 3.

The solvent is sufficiently removed from the above-described mixture, and thereby a metal element-containing powder is obtained. In accordance with the removal of the solvent, the coating compound 3 contained in the surface treatment liquid adheres to the surface of the metal element-containing particle 1. The coating compound 3 may adhere to the whole surface of the metal element-containing particle 1 or may adhere to only a part of the surface of the metal element-containing particle 1. A method for removing the solvent from the mixture is not particularly limited. For example, the mixture is dried, and thereby the solvent can be removed from the mixture. The dry temperature may be 50° C. or higher and 200° C. or lower. In a case where the dry temperature is lower than 50° C., drying is likely to be insufficient, and the coating compound 3 is difficult to adhere to the surface of the metal element-containing particle 1. In a case where the dry temperature is higher than 200° C., the metal element-containing powder is likely to be oxidized. In a case where the dry temperature is within the above-described range, the coating compound 3 is easy to sufficiently adhere to the surface of the metal element-containing particle 1, and the metal element-containing powder is difficult to be oxidized. In a case where the coating compound 3 contains an organophosphate compound, the mixture is dried at a dry temperature of 150° C. or higher, and thereby the organophosphate compound adhering to the surface of the metal element-containing particle 1 is formed into an inorganic coating film.

The metal element-containing powder may be produced by directly mixing the metal element-containing particle 1 and the coating compound 3 so that the coating compound 3 is caused to adhere to the surface of the metal element-containing particle 1.

<Method for Producing Compound Powder>

A method for producing the compound powders 10, 20 of the present embodiment is not particularly limited, and for example, the method may be as follows. First, a resin, a metal element-containing powder, and an organic solvent are uniformly stirred and mixed, and thereby a resin solution is prepared. In other words, the resin composition 2, the metal element-containing powder, and the organic solvent described above are mixed, and thereby a resin solution is prepared. The resin solution may contain a curing agent. The resin solution may contain a curing accelerator. The resin solution may contain additives such as a reactive diluent, a coupling agent, a flow aid, a flame retardant, and a lubricant. The organic solvent is not particularly limited as long as it is a liquid that dissolves the resin composition 2. The organic solvent may be, for example, at least one selected from the group consisting of acetone, N-methylpyrrolidinone (N-methyl-2-pyrrolidone), γ-butyrolactone, dimethylformamide, dimethylsulfoxide, methyl ethyl ketone, methyl isobutyl ketone, toluene, and xylene.

Subsequently, the organic solvent is sufficiently removed from the resin solution, and thereby the compound powders 10, 20 are obtained. In accordance with the removal of the organic solvent, the resin composition 2 adheres to the surface of each of the particles constituting the metal element-containing powder. The resin composition 2 may adhere to the whole surface of each of the particles constituting the metal element-containing powder or may adhere to only a part of the surface of the particle. A method for removing the organic solvent from the resin solution is not particularly limited. For example, the resin solution is dried, and thereby the organic solvent can be removed from the resin solution. A method of drying the resin solution may be, for example, vacuum drying. In order to reduce damage of a mold in a second step described below, a lubricant may be added to the compound powders 10, 20 obtained above. The lubricant is not particularly limited. The lubricant may be, for example, at least one selected from the group consisting of metallic soap and a wax-based lubricant. Furthermore, in order to reduce damage of a mold in the second step, a lubricant may be dispersed in an appropriate dispersion medium to prepare a dispersion liquid, this dispersion liquid may be applied to a wall surface (a wall surface being in contact with a punch) in a mold die, and the applied dispersion liquid may be dried.

According to the above method, the compound powders 10, 20 are obtained.

<Molded Body>

The molded body of the present embodiment may contain the above-described compound powders 10, 20. The molded body may be composed of only the compound powders 10, 20. The molded body may contain at least one selected from the group consisting of the uncured resin composition 2, a semi-cured product of the resin composition 2 (B-stage resin composition 2), and a cured product of the resin composition 2 (C-stage resin composition 2). The molded body may be a cured product of the above-described compound powders 10, 20.

<Method for Producing Molded Body>

A method for producing a molded body of the present embodiment may include a step of pressurizing the compound powders 10, 20 in a mold. The method for producing a molded body may include only the step of pressurizing the compound powders 10, 20 in a mold or may include other steps in addition to the pressurizing step. The method for producing a molded body may include a first step, a second step, and a third step. Hereinafter, details of each step will be described.

In the first step, the compound powders 10, 20 are produced by the above-described method.

In the second step, the compound powders 10, 20 are pressurized in the mold, and thereby a molded body (B-stage molded body) is obtained. Herein, the resin composition 2 is filled between the particles constituting the metal element-containing powder. Further, the resin composition 2 functions as a bonding material (binder) and binds the particles constituting the metal element-containing powder to each other. When the melt viscosity of the resin composition 2 at 100° C. is 10 Pa·s or less, friction (interface friction) between the metal element-containing particle 1 and the resin composition 2 contained in the compound powders 10, 20 is reduced. Therefore, in the process in which a molded body is formed from the compound powders 10, 20, the metal element-containing particles 1 are likely to move in the resin composition 2, and the metal element-containing particles 1 are likely to be densely filled. As a result, the proportion of the metal element-containing particles 1 occupied in the molded body can be increased, and thereby the density of the molded body can be increased. Furthermore, when the melt viscosity of the resin composition 2 at 100° C. is 0.01 Pa·s or more, the mechanical strength of a molded body formed from the compound powders 10, 20 can be increased. Therefore, when the melt viscosity of the resin composition 2 at 100° C. is 0.01 Pa·s or more and 10 Pa·s or less, a molded body having both of a high density and a high mechanical strength can be produced. As the pressure to be applied to the compound powders 10, 20 increases, the density of the molded body is likely to be increased, and the mechanical strength of the molded body is likely to be increased. In the case of producing a bonded magnet, as the pressure to be applied to the compound powders 10, 20 increases, the magnetic flux density of the bonded magnet is likely to be increased, and the mechanical strength of the bonded magnet is likely to be increased. The pressure to be applied to the compound powders 10, 20 may be, for example, preferably 500 MPa or more and 2500 MPa or less and more preferably 1400 MPa or more and 2000 MPa or less. In a case where the pressure to be applied to the compound powders 10, 20 is within the above-described range, the mass-producibility of the molded body is likely to be improved, and the lifetime of the mold is likely to be lengthened.

In the third step, the molded body is cured by a heat treatment to obtain a C-stage molded body. The heat treatment temperature is sufficient to be a temperature at which the resin composition 2 in the molded body is sufficiently cured. The heat treatment temperature may be, for example, preferably 150° C. or higher and 300° C. or lower and more preferably 175° C. or higher and 250° C. or lower. In order to suppress the oxidation of the metal element-containing particle 1 in the molded body, the heat treatment is preferably performed under an inert atmosphere. In a case where the heat treatment temperature is higher than 300° C., the metal element-containing particle 1 may be oxidized or the resin cured product may be degraded by a trace amount of oxygen inevitably contained in the atmosphere of the heat treatment. In order to sufficiently cure the resin composition 2 while suppressing the oxidation of the metal element-containing particle 1 and the degradation of the resin cured product, the maintaining time for the heat treatment temperature may be preferably several minutes or more and 4 hours or less and more preferably 5 minutes or more and 1 hour or less.

### EXAMPLES

Hereinafter, the present invention will be described in more detail by Examples and Comparative Examples; however, the present invention is not limited by these examples at all.

(Preparation of Surface Treatment Liquid)

Into a 50-mL poly bottle (polyethylene bottle), 19.4 g of pure water and 19.4 g of ethanol (manufactured by Wako Pure Chemical Industries, Ltd.) were put. The poly bottle was shaken, and thereby the liquids in the poly bottle were mixed. While the liquids in the poly bottle were stirred with a dropper, 1.20 g of isotridecyl acid phosphate (organophosphate compound) was added, as the coating compound, dropwise to the liquids in the poly bottle. According to the above method, a coating compound solution was obtained.

As the coating compound, JP-513 manufactured by Johoku Chemical Co., Ltd. was used. The coating compound is represented by chemical formula 1 below. In chemical formula 1 below, n is 2. The number of carbon atoms of the alkyl chain of the coating compound is 13.

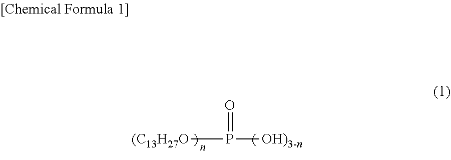

(Production of Metal Element-Containing Powder)

Into a poly bottle, 200 g of a Sm—Fe—N alloy powder manufactured by NICHIA CORPORATION as the metal element-containing particle and 20.0 g of the above-described surface treatment liquid were put. The poly bottle was shaken for 10 minutes, and thereby the metal element-containing particle and the surface treatment liquid were mixed to obtain a mixture. The mixture in the poly bottle was transferred into a tray made of metal, and then the tray was put in an oven heated to 100° C. in advance. The mixture was heated in the oven, and thereby the mixture was dried. The dry temperature was 100° C. The dry time was 1 hour. According to the above method, a metal element-containing powder was obtained. The metal element-containing powder included metal element-containing particles and a coating compound covering the surface of each metal element-containing particle. Hereinafter, a treatment of covering the surface of the metal element-containing particle with the coating compound is denoted as “surface treatment”.

### Reference Example 1

[Movement Property of Metal Element-Containing Powder by Centrifugal Separation]

Into a 150-mL ointment container, 40.0 g of an epoxy resin and 5 g of the above-described metal element-containing powder were put. As the epoxy resin, EPICLON 860 manufactured by DIC Corporation was used. The raw materials in the ointment container were stirred five times by using a rotary and revolutionary stirring machine. The setting of the rotary and revolutionary stirring machine in each time was a stirring mode. The revolution speed in each time was 1000 rpm. The stirring time in each time was 1 minute. As the rotary and revolutionary stirring machine, ARE-500 manufactured by THINKY CORPORATION was used. According to the above method, a dispersion liquid in which the metal element-containing powder was dispersed in the epoxy resin was obtained. The obtained dispersion liquid was put in a 30-mL glass bottle.

The centrifugal separation of the dispersion liquid in the glass bottle was performed by using the rotary and revolutionary stirring machine. The setting of the rotary and revolutionary stirring machine was a defoaming mode. The revolution speed was 2000 rpm. The centrifugal separation time was 1 minute. The precipitation state of the metal element-containing powder in the dispersion liquid after the centrifugal separation was confirmed by visual inspection. As a result, the precipitation of the metal element-containing powder was confirmed.

[Movement Property of Metal Element-Containing Powder in Magnetic Field]

A dispersion liquid was obtained by the same method as described above. The obtained dispersion liquid was put in the 30-mL glass bottle. An image of the dispersion liquid of Reference Example 1 immediately after production is shown in (a) in FIG. 3. The glass bottle was left to stand still on a neodymium magnet for 6 minutes. The magnetic flux density of the neodymium magnet was 0.55 T. The precipitation state of the metal element-containing powder in the dispersion liquid after being left to stand still on the magnet was confirmed by visual inspection. An image of the dispersion liquid of Reference Example 1 after being left to stand still on the neodymium magnet is shown in (b) in FIG. 3. From comparison between (a) and (b) in FIG. 3, the precipitation of the metal element-containing powder was confirmed.

### Reference Example 2

In Reference Example 2, the above-described Sm—Fe—N alloy powder was used without any changes as the metal element-containing powder. That is, the metal element-containing powder of Reference Example 2 was the Sm—Fe—N alloy powder not subjected to the surface treatment. A dispersion liquid of Reference Example 2 was obtained by the same method as in Reference Example 1 except for the above matter.

The precipitation state of the metal element-containing powder in the dispersion liquid after the centrifugal separation was confirmed by the same method as in Reference Example 1. As a result, the precipitation of the metal element-containing powder was confirmed. The precipitation state of the metal element-containing powder in the dispersion liquid after being left to stand still on the magnet was confirmed by the same method as in Reference Example 1. An image of the dispersion liquid of Reference Example 2 immediately after production is shown in (c) in FIG. 3. An image of the dispersion liquid of Reference Example 2 after being left to stand still on the neodymium magnet is shown in (d) in FIG. 3. From comparison between (c) and (d) in FIG. 3, the precipitation of the metal element-containing powder was confirmed.

As clearly understood from comparison between (b) and (d) in FIG. 3, the amount of the metal element-containing powder of Reference Example 1 precipitated on the bottom of the glass bottle was larger than that of Reference Example 2. Such a difference between Reference Examples 1 and 2 is caused due to the presence or absence of the coating compound covering the metal element-containing particle. That is, a difference in precipitation amount between Reference Example 1 and Reference Example 2 shows that friction between the resin composition and the metal element-containing powder is reduced by the coating compound.

### Example 1

[Production of Compound Powder]

Into a 500-mL poly bottle, 3.582 g of a bisphenol F type epoxy resin, 2.418 g of a phenolic resin, 0.036 g of a curing accelerator, and 90.0 g of acetone (manufactured by Wako Pure Chemical Industries, Ltd.) were put. The raw materials in the poly bottle were stirred for 10 minutes, and thereby a resin composition solution was obtained. A part of the resin composition solution excluding the solvent (acetone or the like) corresponds to the resin composition.

As the bisphenol F type epoxy resin, YDF8170C (melt viscosity: 1300 mPa·s) manufactured by Nippon Steel & Sumikin Chemical Co., Ltd. was used.

As the phenolic resin, HP-850N manufactured by Hitachi Chemical Company, Ltd. was used.

As the curing accelerator, HISHICOLIN PX-4PB manufactured by NIPPON CHEMICAL INDUSTRIAL CO., LTD. was used.

Into the above-described poly bottle, 194 g of the metal element-containing powder obtained above was put. The poly bottle was shaken for 10 minutes, and thereby the raw materials in the poly bottle were mixed to obtain a mixture. The mixture in the poly bottle was transferred into a 300-mL flask. Acetone was distilled from the mixture at 30° C. by using an evaporator. The mixture in the flask was transferred into a tray made of metal. The tray was put into a vacuum desiccator. The mixture was dried for 24 hours at normal temperature under reduced pressure to obtain a compound powder.

[Production of Molded Body]

The compound powder of Example 1 was filled in a mold. The dimension of the bottom surface of the mold was a longitudinal width 7 mm×a lateral width 7 mm. A pressure was applied to the compound in the mold from a height direction by using a hydraulic pressing machine, and thereby a compressed molded body was obtained. The pressure applied to the compound was 100 MPa (1 ton/cm²). The compressed molded body was put into a dryer. The temperature inside the dryer was increased from normal temperature at 5° C./min. After the temperature inside the dryer reached 200° C., the temperature was maintained for 10 minutes. Thereafter, the compressed molded body was taken out of from the dryer and the temperature of the compressed molded body was returned to normal temperature. According to the above method, a molded body was obtained.

[Measurement of Density of Molded Body]

The dimension (longitudinal width, lateral width, height) of the molded body of Example 1 was measured by using a micrometer, and thereby a volume V of the molded body was obtained. A mass W of the molded body of Example 1 was measured by using an electronic balance. A density W/V (unit: Mg/m³) of the molded body of Example 1 was calculated by dividing W by V. The density of Example 1 is shown in Table 1 below.

[Measurement of Melt Viscosity of Resin Composition]

A resin composition solution of Example 1 was obtained by the same method as described above. The solvent (acetone or the like) was distilled from the resin composition solution at 30° C. by using an evaporator. Further, the resin composition was dried for 24 hours at normal temperature under vacuum. The melt viscosity of the resin composition at each temperature of 30° C. and 100° C. was measured by using a rheometer. The melt viscosity curve was measured at a temperature increase rate of 10° C./min The melt viscosity (unit: Pa·s) of Example 1 at each temperature is shown in Table 1 below. In Table 1 below, “Melt viscosity at 30° C.” means the melt viscosity of the resin composition at 30° C. “Melt viscosity at 100° C.” means the melt viscosity of the resin composition at 100° C.

### Examples 2 to 6

In production of each compound powder of Examples 2 to 6, compositions shown in Table 1 below were used as raw materials for the compound powder. The mass (unit: g) of each composition used in Examples 2 to 6 was a value shown in Table 1 below. Each of compound powders of Examples 2 to 6 was individually produced by the same method as in Example 1 except for the above matters. Each of molded bodies of Examples 2 to 6 was individually produced by the same method as in Example 1. The density of each of molded bodies of Examples 2 to 6 was individually measured by the same method as in Example 1. The melt viscosity of each of resin compositions of Examples 2 to 6 was individually measured by the same method as in Example 1. Each measurement result is shown in Table 1 below.

EP-828EL described in Table 1 below is a bisphenol A type epoxy resin (melt viscosity: 12000 mPa·s) manufactured by Mitsubishi Chemical Corporation.

YX-4000H described in Table 1 below is a biphenyl type epoxy resin (ICI viscosity: 2 dPa·s) manufactured by Mitsubishi Chemical Corporation.

HP-4032D described in Table 1 below is a naphthalene type epoxy resin (ICI viscosity: 600 dPa·s) manufactured by DIC Corporation.

EPPN502H described in Table 1 below is a salicylaldehyde novolac type epoxy resin (ICI viscosity: 3 dPa·s) manufactured by Nippon Kayaku Co., Ltd.

N695 described in Table 1 below is an ortho-cresol novolac type epoxy resin manufactured by DIC Corporation.

YED188 described in Table 1 below is alkyl monoglycidyl ether (melt viscosity: 2 mPa·s) manufactured by Mitsubishi Chemical Corporation.

“Surface-treated SmFeN powder” described in Table 1 below means an Sm—Fe—N alloy powder subjected to the surface treatment and is the metal element-containing powder obtained above.

“Untreated SmFeN powder” described in Table 1 below means an Sm—Fe—N alloy powder not subjected to the surface treatment and is the above-described Sm—Fe—N alloy powder.

### Comparative Examples 1 to 4

In production of each compound powder of Comparative Examples 1 to 4, compositions shown in Table 1 below were used as raw materials for the compound powder. The mass (unit: g) of each composition used in Comparative Examples 1 to 4 was a value shown in Table 1 below. Each of compound powders of Comparative Examples 1 to 4 was individually produced by the same method as in Example 1 except for the above matters. Each of molded bodies of Comparative Examples 1 to 3 was individually produced by the same method as in Example 1. The density of each of molded bodies of Comparative Examples 1 to 3 was individually measured by the same method as in Example 1. The melt viscosity of each of resin compositions of Comparative Examples 1 to 4 was individually measured by the same method as in Example 1. Each measurement result is shown in Table 1 below. However, the melt viscosity of each resin composition of Comparative Examples 2 and 3 at 30° C. could not be measured. The melt viscosity of the resin composition of Comparative Example 4 at 100° C. could not be measured. A molded body of Comparative Example 4 could not be produced.

TABLE 1

| | | | | | | | | Com- | Com- | Com- | Com- |
|---|---|---|---|---|---|---|---|---|---|---|---|
| | | | | | | | | parative | parative | parative | parative |
| | | Example | Example | Example | Example | Example | Example | Example | Example | Example | Example |
| Table 1 | | 1 | 2 | 3 | 4 | 5 | 6 | 1 | 2 | 3 | 4 |
| Epoxy resin (g) | YDF8170C | 3.582 | — | — | — | — | — | — | — | — | — |
| | EP-828EL | — | 3.796 | — | 3.416 | — | — | — | — | — | 2.278 |
| | YX-4000H | — | — | 3.840 | — | 3.456 | 3.840 | — | — | — | — |
| | HP-4032D | — | — | — | — | — | — | 3.429 | — | — | — |
| | EPPN502H | — | — | — | — | — | — | — | 3.652 | — | — |
| | N695 | — | — | — | — | — | — | — | — | 3.994 | — |
| Reactive diluent (g) | YED188 | — | — | — | 0.381 | 0.381 | — | — | — | — | 1.524 |
| Phenolic resin (g) | HP850N | 2.418 | 2.204 | 2.160 | 2.203 | 2.163 | 2.160 | 2.571 | 2.348 | 2.006 | 2.198 |
| Curing accelerator (g) | PX-4PB | 0.036 | 0.036 | 0.036 | 0.036 | 0.036 | 0.036 | 0.036 | 0.036 | 0.036 | 0.036 |
| Solvent (g) | Acetone | 90 | 90 | 90 | 90 | 90 | 90 | 90 | 90 | 90 | 90 |

| | | | | | | | | | | |
|---|---|---|---|---|---|---|---|---|---|---|
| Surface-treated SmFeN powder (g) | 194 | 194 | 194 | 194 | 194 | — | 194 | 194 | 194 | 194 |
| Untreated SmFeN powder (g) | — | — | — | — | —- | 194 | — | — | — | — |
| Melt viscosity (Pa · s) at 30° C. | 100 | 100 | 900 | 50 | 80 | 900 | 11000 | — | — | 8 |
| Melt viscosity (Pa · s) at 100° C. | 1 | 2 | 0.9 | 2 | 0.7 | 0.9 | 12 | 200 | 150 | — |
| Density (Mg/m³) of molded body | 4.21 | 3.98 | 4.01 | 4.05 | 4.22 | 3.81 | 3.76 | 3.68 | 3.64 | — |

(Evaluation Results)

As shown in Table 1 described above, the densities of the molded bodies of all Examples were equal to or more than a target value (3.8 Mg/m³). On the other hand, the density of the molded body of each of Comparative Examples 1 to 3 was confirmed to be smaller than the target value. Also in all Comparative Examples 1 to 3, the melt viscosity of the resin composition at 100° C. was too high, and thus the density of the molded body was small The melt viscosity of the resin composition of Comparative Example 4 at 100° C. was below a measurement limit value and smaller than 0.01 Pa·s. In Comparative Example 4, the melt viscosity of the resin composition at 100° C. was too low, and thus a molded body could not be produced. The density of the molded body of Example 3 in which the metal element-containing particle was subjected to the surface treatment was larger than that of Example 6 in which the metal element-containing particle was not subjected to the surface treatment.

### INDUSTRIAL APPLICABILITY

The compound powder of the present invention is suitable for a material for producing a molded body having a high density, and thereby has a high industrial value.

### REFERENCE SIGNS LIST

1: metal element-containing particle, 2: resin composition, 3: coating compound, 10, 20: compound powder.

1. A compound powder comprising:
metal element-containing particles; and
a resin composition covering the metal element-containing particle, wherein
a melt viscosity of the resin composition at 100° C. is 0.01 Pa·s or more and 10 Pa·s or less.

2. The compound powder according to claim 1, wherein a melt viscosity of the resin composition at 30° C. is 10 Pa·s or more and 100 Pa·s or less.

3. The compound powder according to claim 1, wherein a coating compound covering the metal element-containing particle is interposed between the metal element-containing particle and the resin composition, and
the coating compound has an alkyl chain.

4. The compound powder according to claim 3, wherein the number of carbon atoms of the alkyl chain is 4 or more and 30 or less.

5. The compound powder according to claim 1 wherein the compound powder is used in a bonded magnet.
